(19) United States
(12) Patent Application Publication
(10) Pub. No.: US 2008/0285622 A1
(43) Pub. Date: Nov. 20, 2008

(54) Detachable Tag-Based Temperature Sensor For Use In Heating Of Food And Cookware

(75) Inventors: Warren S. Graber, Hoffman Estates, IL (US); Reinhard Metz, Wheaton, IL (US); William C. Mish, Chicago, IL (US)

Correspondence Address: MICHAEL P. MAZZA, LLC, 686 CRESCENT BLVD., GLEN ELYN, IL, 60137, US

(73) Assignee: COOKTEK, LLC, Chicago, IL (US)

(21) Appl. No.: 11/750,571

(22) Filed: May 18, 2007

(51) Int. Cl. G01K 13/00; G01K 1/14

(52) U.S. Cl. 374/152; 248/200

(57) ABSTRACT

A detachable, magnetic tagging mechanism, and a system and method for using it, for conveying information related to control over the sensing of parameters, such as the heating of cookware or other food containers, to a reader communicating with, e.g., heating controls of a heater. The tagging mechanism may be removably attached to the cookware or other food container, is heat-resistant, and its shape can be changed to accommodate the heating of different sizes and shapes of cookware or other items. The tagging mechanism, system and method of the invention may be employed with different types of heaters, such as but not limited to magnetic induction heaters, and may communicate with readers using RFID or other technology and other communication modes and media.

### BACKGROUND OF THE INVENTION

The present invention generally relates to devices used to sense temperature or other parameters (e.g., humidity, weight, etc.) in the operation of appliances. More particularly, the invention relates to a magnetic attachment to metal, ceramic or glass cookware, for example, useful in controlling the heating of cookware in closed-loop operations of appliances.

Various methods are known for heating cookware and food containers. As one example, radio-frequency identification (RFID) tagging systems have been used to activate and control magnetic induction heating systems for use in heating foods and associated food containers and cookware. Use of such systems allows objects not physically connected to a magnetic induction heater to be heated and temperature-regulated using RFID technology. In such systems, an RFID tag having a temperature sensor may be mounted within an item to be heated, such as cookware, while the magnetic induction heater may include an RFID reader. When the tagged object comes within the reading field of the RFID reader, the tag may be used to transmit information such as the class of object being heated, so that the heater control circuitry may use the information to commence an appropriate heating cycle for heating and temperature-regulating the object. Various such systems are available, including those disclosed in U.S. Pat. No. 6,025,725 to Gershenfeld et al., and U.S. Pat. Nos. 6,320,169 and 6,953,919 to Clothier, the entire disclosures of each of these three patents hereby being incorporated by reference herein. Use of this technology enables relatively precise heating and temperature regulation.

Other non-contact/indirect, remote control methods are known or may be devised. As non-limiting examples, remote controller devices used with televisions typically operate based on optical (infrared) communication. Non-contact modes of communication other than RFID may be used, likewise, for measuring the temperature of cookware and food containers, such as those involving communication via optical means, ultrasound, infrared, or other communication modes.

It would be advantageous to devise a way to attach temperature-sensing tags to cookware in a manner that enables the tag to be easily removed from the cookware, as well as to be attached to cookware of various sizes, so that the tag may be read (using RFID or other communication modes) by a reader associated with a heating device, such as but not limited to a magnetic induction heating device. The tag must be resistant to and useable in the presence of fairly high temperatures, i.e., those associated with conventional cooking temperatures for foods. The tag should also preferably be rugged and durable, cleanable, and resistant to deterioration when subjected to the presence of food or cleaning materials and methods.

Accordingly, there is a need to mount heat-resistant tagging mechanisms to cookware of various shapes and sizes, in a manner that enables the tagging mechanism to be easily removed from the metal cookware and/or food container, to enable control over cooking and/or warming applications of food contained therein.

### Definition of Cliam Terms

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Closed-loop” means an operation influenced or controlled by the effect it has on a measured parameter. For example, a temperature sensor may be used to control heating in a closed-loop operation.

“Cookware” means cooking, serving or delivery containers for food, including but not limited to dishes, pots, trays including buffet trays and warming trays, etc.

“Food” means any item or material which may be normally ingested by humans, including solid or liquid matter.

“Indirect heater” or “indirect heating” or “indirect heating system” means a heater or method of heating, or system involving such heating, respectively, in which food contained by an item of cookware or other cooking, serving or delivery food container, is heated through conduction of heat from the cookware or container to the food.

“Reader” means a device capable of receiving information from a tag relevant to the heating of cookware of other cooking-, serving-, or delivery-related food containers, and of transmitting this information to heating controls associated with an indirect heater.

“RFID technology” means a tagging system including but not limited to a tag having information regarding an object, such as its temperature, humidity, volume or weight, and a reader in communication with the tag and with an appliance such as an induction heater separated by some distance from the tag.

“Tag” means a device possessing information relevant to the heating of cookware or other cooking-, serving- or delivery-related food containers, that is capable of transmitting sensor information such as but not limited to temperature, humidity, volume or weight to a reader associated with heating controls of an indirect heater, which communication may occur through the mode of RFID, optical, ultrasound, or other modes.

### SUMMARY OF THE INVENTION

The objects mentioned above, as well as other objects, are solved by the present invention, which overcomes disadvantages of prior tagging mechanisms and systems used with heating devices for cooking and/or warming applications, while providing new advantages not previously obtainable with such tagging mechanisms and systems.

In a preferred embodiment, a detachable apparatus is provided for measuring the temperature of cookware, providing for closed-loop heating control. Using this detachable apparatus, an item of cookware may be heated in the following manner. A cookware item has a tag associated with it. The tag is capable of communication with a reader; the reader is in communication with heating controls of a heater, such as but not limited to a magnetic induction heater. A magnetic detachable coupler carrying the tag is provided. The coupler permits removable attachment of the coupler to the cookware item.

In one embodiment, RFID tags and readers may be employed. In a preferred embodiment, the magnetic coupler includes a housing in which the tag is located, and a tongue portion with a temperature sensor which may be in electrical communication with the tag. Preferably, the tongue portion is in abutting contact with the cookware item when the magnetic coupler is magnetically coupled to the cookware item. When attached to the bottom of cookware, the tongue portion preferably is relatively thin, and has a thickness of less than about 0.100 inches, for example, so that the cookware does not rock during heating. The tongue portion may be made of Kapton or polyamide, and may be made of multiple layers of such material, with wires located between two layers, for example, in the manner that printed circuit boards are fabricated. The tag may be hermetically sealed from the environment of the cookware item, using a gluing or potting compound, for example. The housing may be generally triangularly-shaped in cross-section, or may have other cross-sectional shapes, preferably provided the housing with a length which provides that the tag is in receptive communication with an antenna, such as an antenna which may be located beneath the surface of an oven range.

The invention has advantage in applications other than heating cookware using magnetic induction heating controls. For example, the tag and the reader may communicate optically, or using ultrasound waves. Also, parameters other than temperature may be sensed and controlled, such as humidity, weight, etc.

In a preferred embodiment, the detachable magnetic coupler includes a housing and a first endcap removably attached to the housing, and one or more magnets may be located within the endcap. The first endcap may be removably attachable to the housing, and shaped, such as a curvilinear shape, to facilitate attachment to a first (e.g., curved) cookware item. The first endcap may be removed, and a second endcap, also removably attachable to the housing, and having a different shape than the first endcap, may be used to facilitate attachment of the magnetic coupler to a second cookware item having a different size than the first cookware item. Preferably, the first and second endcaps have an engaging surface which matingly abuts an exterior, engaging surface of the correspondingly-sized cookware item.

In another embodiment, double-sided adhesive means may be employed for attachment to the tagging mechanism, permitting the tagging mechanism to be attached to a non-metal cookware item.

In another embodiment, a system may be employed using a detachable apparatus for measuring temperature within cookware, providing for closed-loop heating control. In such a system, an item of cookware to be heated is provided with a tag. A heater is also provided, having heating controls in communication with a reader; the reader is capable of receiving information from the tag. A magnetic detachable coupler carries the tag. The coupler permits removable attachment of the coupler to the cookware item. Using this system, parameters other than temperature may be sensed and controlled by a control apparatus which variably, quantitatively controls the parameter to be measured or sensed. Such parameters may include, but are not limited to, humidity, weight, etc. The control apparatus may be a humidifier, a scale, an optical and/or infrared measuring and controlling instrument, etc. The control apparatus may be in communication with a reader capable of receiving information from the tag. A magnetic detachable coupler may carry the tag. The coupler permits removable attachment of the coupler to the control apparatus.

In yet another embodiment, a method is provided for attaching a tagging mechanism to an item of cookware to be heated by a heater. The heater has control circuitry in communication with a reader capable of receiving heat-related information from a tagging mechanism. Using this method, a tagging mechanism is magnetically coupled, in a selectively detachable manner, to the cookware item. The shape of the tagging mechanism may be transformed to enable the tagging mechanism to fit cookware items having different shapes and sizes. The tagging mechanism may include a housing and first endcap abutting the cookware item, and the transforming step may involve replacing the first endcap with a second endcap having a different shape. Magnetic induction heating, for example, may be employed to heat the cookware using information provided by the tagging mechanism that has been communicated to the reader, and from the reader to the heater control circuitry.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings, in which:

FIGS. 1 and 2 are perspective and schematic views, respectively, of a preferred embodiment of a magnetic induction heating system which may be used in conjunction with the present invention;

FIGS. 3 and 4 are perspective views disassembled and assembled views, respectively, of a preferred embodiment of the magnetically attachable and detachable tagging mechanism of the present invention;

FIG. 3a is a partial side, cross-sectional view of the tongue portion and a temperature sensor;

FIG. 5 is a partial perspective view illustrating attachment of the tagging mechanism shown in FIG. 4 to an item of cookware;

FIG. 6 is a partial perspective view showing the tagging mechanism/pot combination sitting on the range of a programmable heater;

FIG. 7 is a perspective view of the touch-screen programmable control console of the programmable heater shown in FIG. 6; and

FIG. 8 is a top view of a printed circuit board housing an antenna which may be used in conjunction with a magnetic induction heater which is RFID-controlled.

The components in the drawings are not necessarily to scale, emphasis instead being placed upon clearly illustrating the principles of the present invention.

### DETAILED DESCRIPTION OF THE PREFERRED EMBODIMENT

Set forth below is a description of what are believed to be the preferred embodiments and/or best examples of the invention claimed. Future and present alternatives and modifications to this preferred embodiment are contemplated. Any alternatives or modifications which make insubstantial changes in function, in purpose, in structure, or in result are intended to be covered by the claims of this patent.

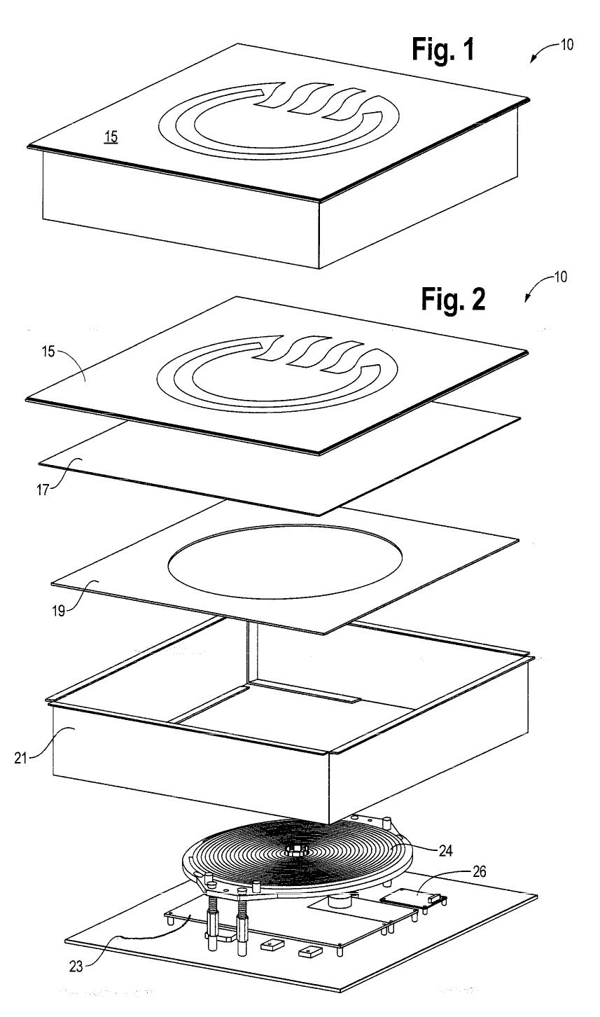

Referring to FIGS. 1 and 2, in a preferred embodiment of the present invention, a suitable heater, such as magnetic induction heater 10, may be employed to heat cookware (as broadly defined here) for holding or storing food to be cooked or warmed, including for delivery or to be served. Of course, it will be understood that other forms of non-contact or indirect heating (e.g., radiant, etc.), or other modes of communication between a tag and a reader (e.g., optical, infrared, ultrasound, etc.) may be used in conjunction with the principles of the present invention.

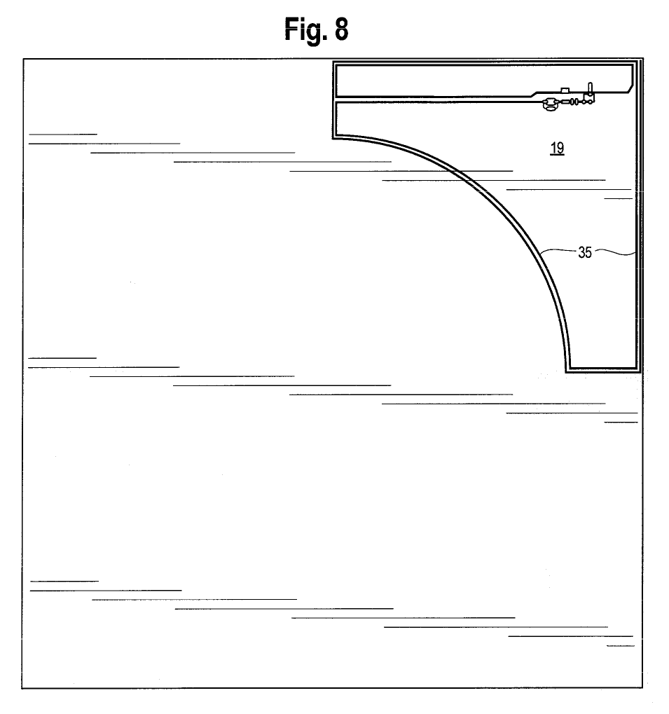

Referring to FIG. 2, magnetic induction heater 10 may include a range top 15, which may be made of glass, for example, a layer of insulation 17, for example, a printed circuit board (PCB) 19 which may hold an antenna 35, for example (see FIG. 8), another PCB 23, and a suitable cover or housing 21. Various components may be mounted on PCB 23, such as inductor coil 24 and RFID reader 26. The working principles of magnetic induction heater 10 are known in the art, and mentioned in the above-described Clothier patents, for example.

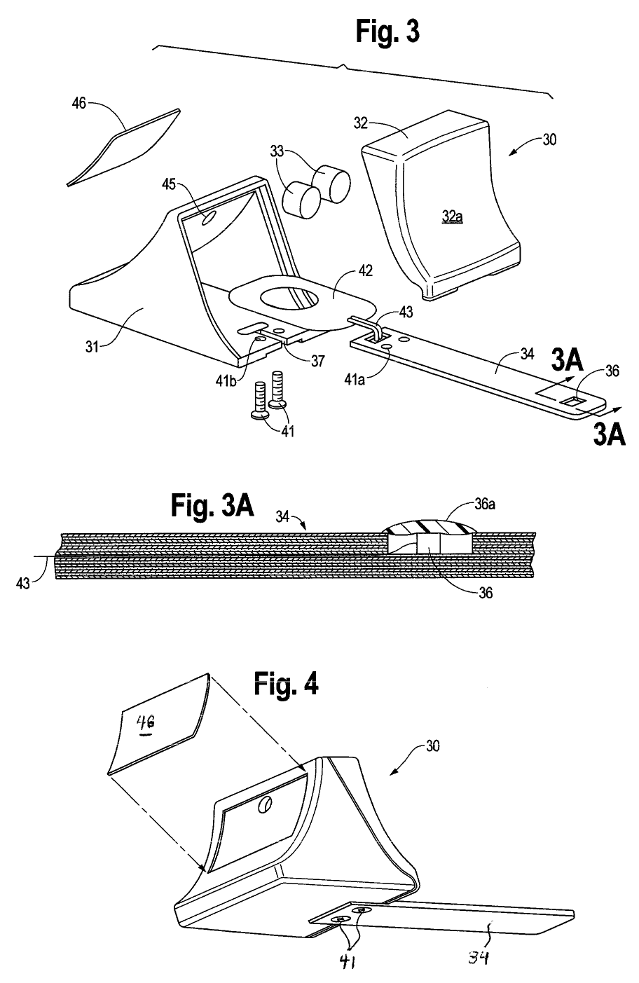

Referring now to FIGS. 3 and 4, a preferred embodiment of tagging mechanism 30 is shown. Tagging mechanism 30 may include housing 31, end cap 32, magnets 33, tongue 34, fasteners 41, a temperature sensor 36, and a built-in antenna 42. To assemble the preferred embodiment, a resistance temperature detector (RTD) 36, for example, may be soldered or otherwise attached at the end of tongue 34. Tongue 34 may be composed of layers of kapton or polyamide, for example, as shown in enlarged side view FIG. 3A. A thermally conductive epoxy (e.g., Loctite 454) may be coated over RTD 36, creating bubble 36a above the tongue to improve electrical contact with cookware, for example. An RFID tag 42, for example, may then be soldered to the tongue using short leads of wire 43 which run through tongue 34 from RTD 36 (see FIG. 3A). Wires 43 may be run up through slot 37 of housing 31, and a thin layer of protective epoxy (not shown, e.g., Loctite 454) may be placed under and over RFID tag 42 to hermetically seal it. Self-tapping screws 41, for example (e.g., #4 by ⅜, 100 deg, flathead), may pass through apertures 41a of the tongue and apertures 41b of the housing to secure tongue 34 to housing 31. Endcap 32 may be secured by adhesive and/or by screws to housing 31.

Magnets 33, which are preferably powerful magnets, such as rare earth magnets (e.g., ⅜″ diameter, ¼″ long), may be glued into cap 32, and cap 32 may then be glued into housing 31. After the adhesives have dried, the housing may be back-filled through fill hole 45 with foam (e.g., Reltek B481 potting compound) to prevent water or other fluids from filling the cavity should the tagging mechanism undergo a wash cycle. A label 46 may be added, covering the fill hole.

RFID tag 42 may now be programmed with information an RFID reader may use for heating controls of appropriately-sized cookware, for example, prior to shipping of the final tagging mechanism.

Housing 31 and endcap 32 may be made of plastic, such as cast urethane, polyethylene, nylon, ABS (acrylonitrile butadiene styrene), etc. Referring to FIGS. 3 and 3A, for strength and to provide the wiring connections from RTD 36 to RFID tag 42, tongue 34 is preferably made in a multi-layer printed circuit process (alternate layers of a strong, durable material such as Kapton and glue, for example, such as a 15-layer tongue, although only two layers may be used to sandwich wires 43). The tongue should be relatively strong to withstand use with heavy metal pots, for example, should not melt at relatively high temperatures (e.g., 300° F. or greater), and should not be unduly heated or its operation otherwise impaired by the communication field/medium (e.g., RFID/magnetic) employed by the tagging mechanism and a communicating reader associated with the control circuitry of the heater.

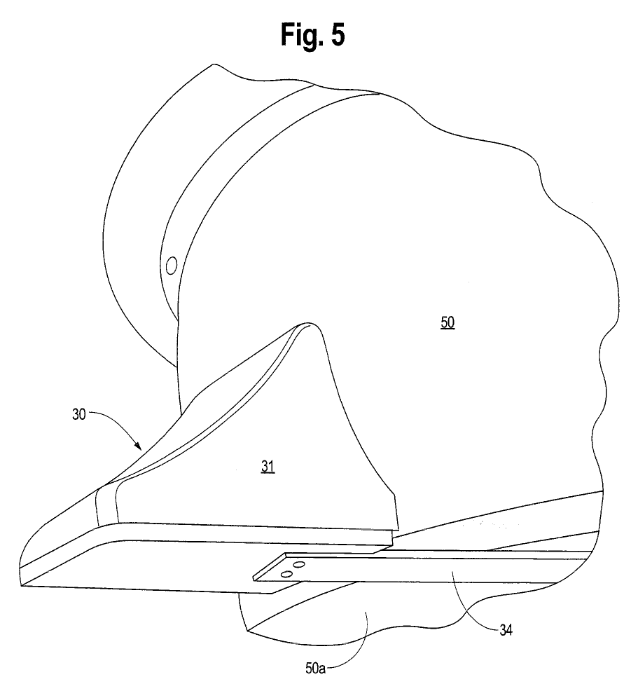

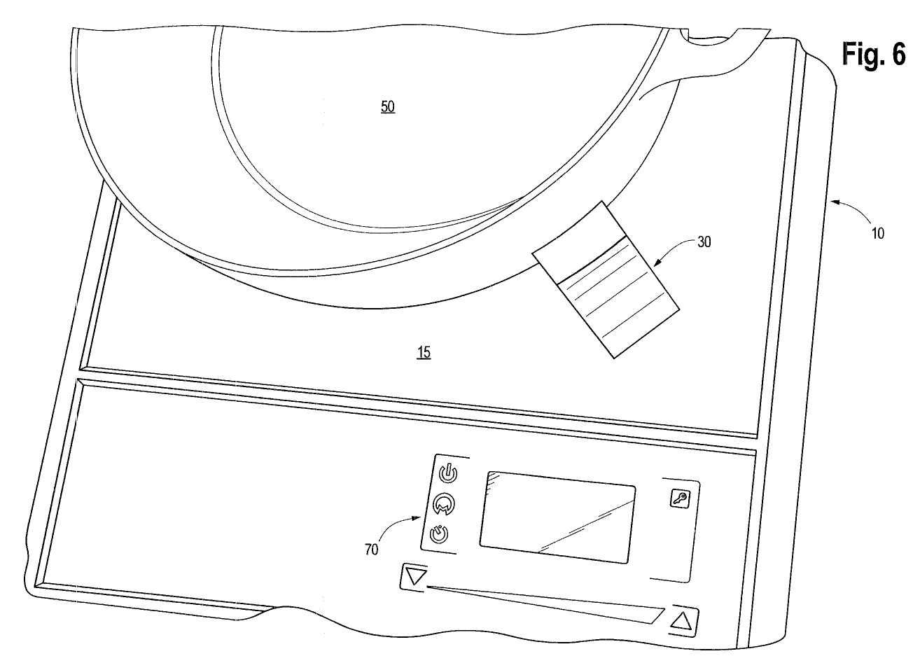

Preferably, tagging mechanism 30 consists of a modular mechanical assembly which may be easily changed to fit (e.g.) cookware of various shapes and sizes. In the preferred embodiment shown in FIGS. 3-4, endcap 32 may be disassembled from housing 31, and a differently-shaped endcap 32, having a different exterior arcuate surface 32a, may be used, for abutting attachment to a differently-sized cookware pot 50 (see FIG. 5) having a similarly-shaped arcuate surface.

Referring now to FIG. 5, when tagging mechanism 30 is magnetically attached to a surface of cookware 50, tongue 34 may be placed in abutting contact with an underside surface 50a of pot 50. The length of tongue 34 (e.g., 2-4 inches, for example), which may vary given the use, will dictate the temperature sensing location on the underside of the pot, for example.

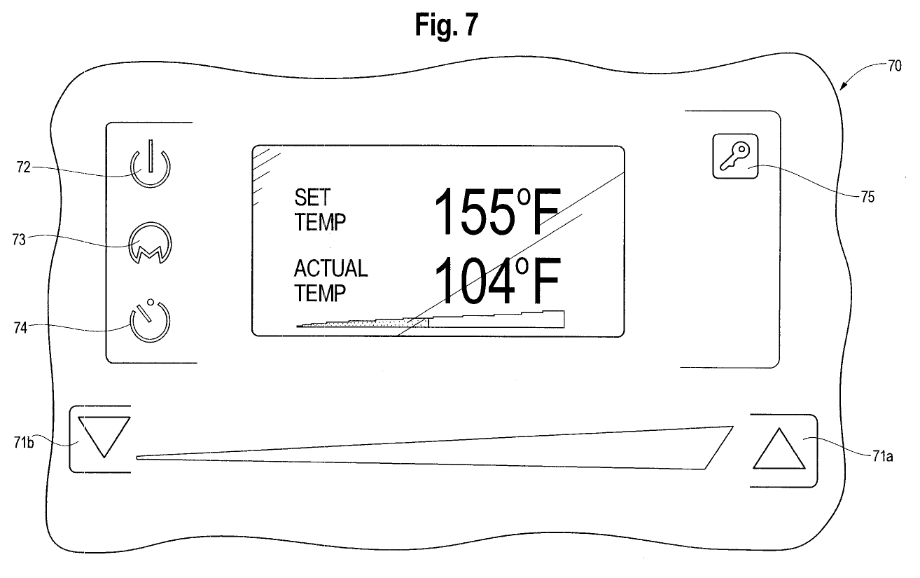

Referring now to FIGS. 6 and 7, a preferred heater form, magnetic induction heater 10, may be used to heat cookware 50 placed on range 15. Once touch-screen control 70 has been programmed with a desired cooking or warming temperature, or a desired cooking or warming cycle or profile, which may be done using temperature control bars 71a, 71b, (e.g.) RFID tagging mechanism 30 may be read by a RFID reader (not shown) associated with the control circuitry of heater 10. Upon receiving heating-related information from tagging mechanism 30 (e.g., indicating the size of the pot or other parameters), the RFID reader may provide this information to the control circuitry of the heater, and heating may commence until the set temperature or other desired temperature cycle is reached. While not important to the invention, as further explanation, and still referring to FIG. 7, touch-screen icons 72-75 may have the following functions, respectively: power on/off; operating mode selector; timer options; and system lock/unlock.

Referring now to FIGS. 1 and 8, printed circuit board 19 of heater 10 may include an antenna 35 shaped to enable the RFID reader to receive communications from the RFID tag associated with tagging mechanism 30. Tongue 34 is preferably of a sufficient length so that the temperature sensor (e.g., RTD 36) is in contact with a “hot” portion of the cookware, for example. Also, preferably, housing 31 has an elongated (e.g., triangular in cross-section) shape, and the cooking vessel is rotationally in position, such that RFID tag 42 is located over or within the periphery of antenna 35 shown in FIG. 8, to provide sufficient reception.

Tongue 34 is preferably relatively thin, such as less than about 0.100″ thick, and more preferably about 0.060″ thick, so that when the tongue is placed below a cookware item, such as a cooking pot, the pot will not rock due to the thickness of the tongue beneath it.

If a food container or item of cookware is not metal-based, it would also be advantageous to provide a mechanism for attaching a tag in this event. For this purpose, double-face adhesive tape, such as 3M tape No. 468, may be attached to a non-metal cookware item such as glass or ceramic cookware, for example, while the other side of the tape may be adhered to the tagging mechanism. The 3M tape identified here is one preferred adhesive as it is temperature-resistant and may also be used in a food environment.

The above description is not intended to limit the meaning of the words used in the following claims that define the invention. For example, while preferred embodiments involving power induction principles applied to movable glass have been described above, persons of ordinary skill in the art will understand that a variety of other designs still falling within the scope of the following claims may be envisioned and used. It is contemplated that future modifications in structure, function or result will exist that are not substantial changes and that all such insubstantial changes in what is claimed are intended to be covered by the claims.

We claim:

1. A detachable apparatus for measuring the temperature of cookware, providing for closed-loop heating control, comprising:
an item of cookware to be heated, the cookware item having a tag associated with it, the tag being capable of communication with a reader in communication with heating controls; and
a magnetic detachable coupler carrying the tag, the coupler permitting removable attachment of the coupler to the cookware item.

2. The detachable apparatus of claim 1, wherein the heating controls employ magnetic induction heating.

3. The detachable apparatus of claim 1, wherein the tag comprises an RFID tag and the reader comprises an RFID reader.

4. The detachable apparatus of claim 1, wherein the magnetic coupler comprises a housing in which the tag is located, and a tongue portion having a temperature sensor.

5. The detachable apparatus of claim 4, wherein the tag is in electrical communication with the tongue portion.

6. The detachable apparatus of claim 4, wherein the tongue portion is in abutting contact with the cookware item when the magnetic coupler is magnetically coupled to the cookware item.

7. The detachable apparatus of claim 4, wherein the tongue portion comprises Kapton.

8. The detachable apparatus of claim 1, wherein the tag is hermetically sealed from the environment of the cookware item.

9. The detachable apparatus of claim 4, wherein the housing is generally triangularly-shaped in cross-section.

10. The detachable apparatus of claim 4, further comprising an antenna facilitating communication between the tag and the reader, and wherein the housing has a length parallel to a longitudinal axis of the tongue portion, the housing length being sufficient to allow positioning of the tag within the housing at a location which is within a reception area of the antenna.

11. The detachable apparatus of claim 1, wherein the tag and the reader communicate using ultrasound waves.

12. The detachable apparatus of claim 1, wherein the tag and the reader communicate optically.

13. The detachable apparatus of claim 1, wherein the magnetic coupler comprises a housing and an endcap removably attached to the housing, and one or more magnets are located within the endcap.

14. The detachable apparatus of claim 1, wherein the magnetic coupler comprises a housing and a first endcap removably attachable to the housing, the first endcap being shaped to facilitate attachment to a first cookware item.

15. The detachable apparatus of claim 14, further comprising a second endcap removably attachable to the housing, the second endcap having a different shape than the first endcap, to facilitate attachment of the magnetic coupler to a second cookware item having a different size than the first cookware item.

16. The detachable apparatus of claim 15, wherein the first and second endcaps have a curved surface which matingly abuts a curved surface of the correspondingly-sized cookware item.

17. The detachable apparatus of claim 1, further comprising a double-sided adhesive means attached to the tagging mechanism, permitting the tagging mechanism to be attached to a non-metal cookware.

18. The detachable apparatus of claim 4, wherein the tongue portion has a thickness of less than about 0.100 inches.

19. A system employing a detachable apparatus for measuring temperature within cookware, providing for closed-loop heating control, comprising:
an item of cookware to be heated, the cookware item having a tag associated with it;
a heater having heating controls in communication with a reader capable of receiving information from the tag; and
a magnetic detachable coupler carrying the tag, the coupler permitting removable attachment of the coupler to the cookware item.

20. A system employing a detachable apparatus for measuring a parameter within cookware, comprising:
an item of cookware to be heated, the cookware item having a tag associated with it;
a control apparatus variably, quantitatively controlling the parameter to be measured, the apparatus being in communication with a reader capable of receiving information from the tag; and
a magnetic detachable coupler carrying the tag, the coupler permitting removable attachment of the coupler to the control apparatus.

21. The system of claim 20, wherein the control apparatus comprises at least one of the following: a heater; a humidifier; or a scale; and wherein the parameter includes at least one of the following: temperature, humidity or weight.

22. A method for attaching a tagging mechanism to an item of cookware to be heated by a heater, the heater having control circuitry in communication with a reader capable of receiving heated-related information from a tagging mechanism, comprising the step of:
magnetically coupling the tagging mechanism, in a selectively detachable manner, to the cookware item.

23. The method of claim 22, further comprising the step of transforming the shape of the tagging mechanism to enable the tagging mechanism to fit cookware items having different shapes and sizes.

24. The method of claim 23, wherein the tagging mechanism further comprising a housing and first endcap abutting the cookware item, and wherein the transforming step involves replacing the first endcap with a second endcap having a different shape.

25. The method of claim 22, further comprising the step of employing magnetic induction heating to heat the cookware using information provided by the tagging mechanism that has been communicated to the reader, and from the reader to the heater control circuitry.
